(19) United States
(12) Patent Application Publication
(10) Pub. No.: US 2020/0180642 A1
(43) Pub. Date: Jun. 11, 2020

(54) VEHICLE CONTROL DEVICE

(71) Applicant: Toyota Jidosha Kabushiki Kaisha, Toyota-shi (JP)

(72) Inventor: Yosuke Takashiro, Toyota-shi, Aichi-ken (JP)

(73) Assignee: Toyota Jidosha Kabushiki Kaisha, Toyota-shi (JP)

(21) Appl. No.: 16/704,694

(22) Filed: Dec. 5, 2019

(30) Foreign Application Priority Data
Dec. 7, 2018 (JP) 2018-229827

(51) Int. Cl. B60W 30/18; G05D 1/02; G08G 1/16; B60W 30/095; G05D 1/00

(52) U.S. Cl. CPC B60W 30/18163; G05D 1/0212; G05D 1/0061; B60W 30/0956; G08G 1/167

(57) ABSTRACT

A vehicle control device includes a merging permission and prohibition determination unit configured to determine whether or not a host vehicle is able to merge while keeping autonomous driving based on a merging destination non-host vehicle situation and a road shape, a traveling controller configured to, in a case where determination is made that the host vehicle is not able to merge while keeping autonomous driving, control traveling, of the host vehicle so as to bring a merging preparation situation, in which a driver of the host vehicle is likely to start a manual operation to make the host vehicle merge, and a manual operation proposition unit configured to, in a case, where the merging preparation situation is brought, propose starting the manual operation to make the host vehicle merge to the driver.

### CROSS-REFERENCE TO RELATED APPLICATIONS

This application claims priority to Japanese Patent Application No. 2018-229827 filed on Dec. 7, 2018, which is incorporated herein by reference in its entirety including the specification, drawings and abstract.

### BACKGROUND

### 1. Technical Field

The present disclosure relates to a vehicle control device.

### 2. Description of Related Art

For example, Japanese Unexamined Patent Application Publication No. 2017-74823 (JP 2017-74823 A) discloses a device that determines permission and prohibition of lane change of a host vehicle based on an inter-vehicle distance and a predicted collision time between the host vehicle and a non-host vehicle traveling on an adjacent lane.

### SUMMARY

On the other hand, in merging from a traveling lane of the host vehicle into a merging destination lane, since the end of the traveling lane is present in front, a merging section is likely to be shortened compared to a section for lane change. For this reason, in manual driving, merging from the traveling lane into the merging destination lane in a limited merging section may be hardly performed. Even in autonomous driving, determination regarding whether or not a non-host vehicle traveling on the merging destination lane has an intention to yield a path in order to make the host vehicle merge into the merging destination lane may not be easily performed, and the host vehicle may be hardly made to merge from the traveling lane into the merging destination lane. Accordingly, in the technical field, it is desirable to more appropriately support merging in the merging section.

Therefore, the present disclosure provides a vehicle control device capable of more appropriately supporting merging in a merging section.

An aspect of the present disclosure relates to a vehicle control device that, in a host vehicle that is able to execute autonomous driving, supports merging of the host vehicle from a traveling lane into a merging destination lane. The vehicle control device includes a non-host vehicle situation acquisition unit, a road shape acquisition unit, a merging permission and prohibition determination unit, a traveling controller, and a manual operation proposition unit. The non-host vehicle situation acquisition unit is configured to acquire a merging destination non-host vehicle situation including a relative position and a relative speed of a non-host vehicle traveling on the merging destination lane with respect to the host vehicle. The road shape acquisition unit is configured to acquire a relative road shape with respect to the host vehicle. The merging permission and prohibition determination unit is configured to determine whether or not the host vehicle during autonomous driving is able to merge from the traveling lane into the merging destination lane while keeping autonomous driving based on the merging destination non-host vehicle situation and the road shape. The traveling controller is configured to, in a case where the merging permission and prohibition determination unit determines that the host vehicle is not able to merge while keeping, autonomous driving, control traveling of the host vehicle through autonomous driving so as to bring a merging preparation situation, in which a driver of the host vehicle is likely to start a manual operation to make the host vehicle merge from the traveling lane into the merging destination lane. The manual operation proposition unit is configured to, in a case where the host vehicle and the merging destination non-host vehicle situation, are brought into the merging preparation situation, propose starting the manual operation to make the host vehicle merge from the traveling lane into the merging destination lane to the driver.

With the vehicle control device, determination is made whether or not the host vehicle is in a situation to be able to merge while keeping autonomous driving based on the merging destination non-host vehicle situation including the relative position and the relative speed of the non-host vehicle traveling on the merging destination lane with respect to the host vehicle and the relative road shape with respect to the host vehicle, in a case where determination is made that the host vehicle is not in a situation to be able to merge while keeping autonomous driving, traveling of the host vehicle through autonomous driving is controlled so as to bring the merging preparation situation in which the driver of the host vehicle is likely to start the manual operation to make the host vehicle merge from the traveling lane into the merging destination lane. Then, when the host vehicle and the merging destination non-host vehicle situation are brought into the merging preparation situation, the proposal of starting the manual operation to make the ihost vehicle merge from the traveling lane into the merging destination lane to the driver is performed. For this reason, the device can more appropriately support mergmg in a limited merging section where all operations are hardly performed through manual driving of the driver since the merging preparation situation is brought through autonomous driving.

The vehicle control device according to the aspect of the present disclosure may further include a merging completion determination unit configured to, after the manual operation proposition unit proposes starting the manual operation to make the host vehicle merge from the traveling lane into the merging destination lane to the driver, determine whether or not merging of the host vehicle from the traveling lane into the merging destination lane is completed by a timing set in advance. The traveling controller may be configured to, in a case where the merging completion determination unit determines that merging of the host vehicle from the traveling lane into the merging destination lane is not completed by the timing, stop the host vehicle. With this, in a ease where the driver who receives the proposal of starting the manual operation to make the host vehicle merge from the traveling lane into the merging destination lane cannot appropriately complete merging of the host vehicle, it is possible to automatically stop the host vehicle. For this reason, the driver easily concentrates on the manual operation to make the host vehicle merge without being distracted by retreat or the like of the host vehicle in a case where merging of the host vehicle cannot be completed. Accordingly the device can more appropriately support merging in the merging section.

According to the aspect of the present disclosure, it is possible to more appropriately support merging in a merging section.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a block diagram showing a vehicle control device according to the embodiment;

FIG. 2 is a schematic view showing an example of a road shape;

FIG. 3 is a schematic view showing an example of a merging preparation situation in the road shape of FIG. 2; and

FIG. 4 is a flowchart showing cooperative merging processing.

### DETAILED DESCRIPTION OF EMBODIMENTS

Hereinafter, an illustrative embodiment will be described referring to the drawings.

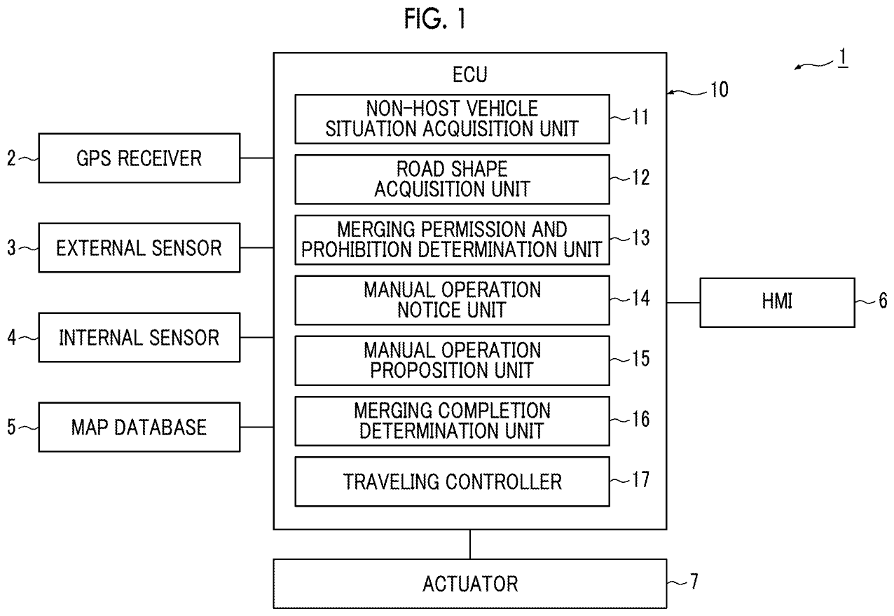

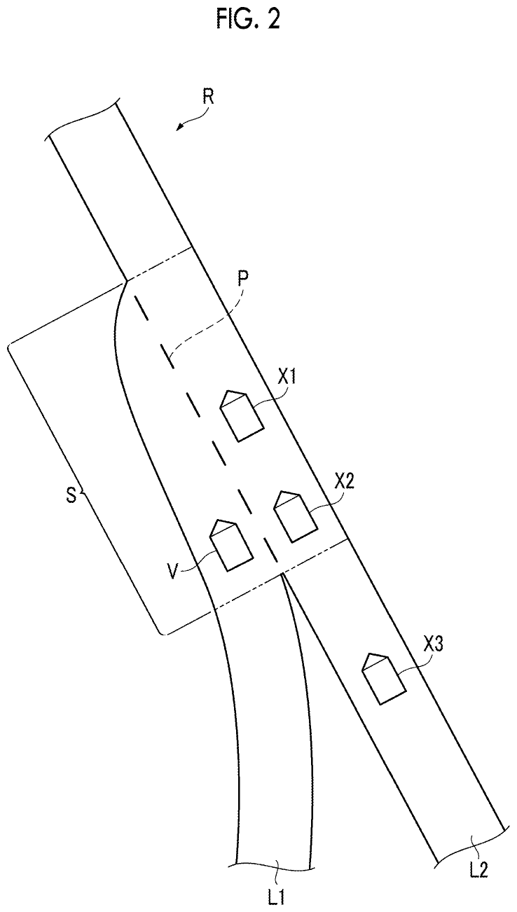

FIG. 1 is a block diagram showing a vehicle control device 1 according to the embodiment. FIG. 2 is a schematic view showing an example of a road shape. As shown in FIGS. 1 and 2, the vehicle control device 1 is a device that, in a vehicle (hereinafter, referred to as a host vehicle V) that is able to execute autonomous driving, supports merging of the host vehicle V from a traveling lane L1 into a merging destination lane L2. The vehicle control device 1 executes cooperative merging processing for implementing appropriate merging using autonomous driving and manual driving in combination in the host vehicle V. “Autonomous driving” refers to making a vehicle autonomously travel toward a destination set in advance through vehicle control. The vehicle that executes autonomous driving does not need a driving operation of the driver, and travels autonomously based on a traveling plan. “Manual driving” refers to making a vehicle travel with a manual operation of the driver.

In the embodiment, as an example, although a situation in which the host vehicle V travels on a road R having a shape shown in FIG. 2 through autonomous driving has been described, the road shape, the arrangement of respective vehicles, and the like are not limited to the situation of FIG. 2. In FIG. 2, the host vehicle V is traveling on the traveling lane L1 as a single lane. The traveling lane L1 merges with the merging destination lane L2 as an adjacent single lane at a merging section S. The traveling lane L1 has an end at a position where the merging section S with the merging destination lane L2 ends, in a moving direction of the host vehicle V, and disappears at the end.

The “merging section S” is a section wdiere the traveling lane L1 merges with the merging destination lane L2, in the road R (traveling lane L1 and the merging destination lane L2). For example, the merging section S is an area of the road R corresponding to an area where the traveling lane L1 and the merging destination lane L2 are connected in a lane width direction (that is, an area where the vehicle is movable between the traveling lane L1 and the merging destination lane L2). More specifically, the merging section S is an area sandwiched between two two-dot-chain lines in the road R of FIG. 2. Here, non-host vehicles X1, X2, X3 are traveling on the merging destination lane L2 in this order. When the host vehicle V enters the merging section S in the traveling lane L1, the host vehicle V traveling on the traveling lane L1 and the non-host vehicle X2 traveling on the merging destination lane L2 are so in a positional relationship as to travel in parallel with each other.

The vehicle control device 1 includes an electronic control unit (ECU) 10 that integrally controls the device. The ECU 10 is an electronic control unit having a central processing unit [CPU], a read only memory [ROM], a random access memory (RAM), and the like, and is constituted as, for example, a computer. For example, a program stored in the ROM is ioaded to the RAM and the program loaded to the RAM is executed on the CPU, whereby the ECU 10 implements functions relating to the cooperative merging processing. The ECU 10 may be constituted of a plurality of ECUs. At least a part of the functions of the ECU 10 may be executed by a server communicable with the host vehicle V.

The ECU 10 is connected to a CPS receiver 2, an external sensor 3, an internal sensor 4, a map database 5, an HMI 6, and an actuator 7.

The GPS receiver 2 receives signal from three or more GPS satellites and acquires positional information indicating the position of the host vehicle V. The positional information includes, for example, a latitude and a longitude. The GPS receiver 2 outputs the acquired positional information of the host vehicle V to the ECU 10. Instead of the GPS receiver 2, another means capable of specifying a latitude and a longitude where the host vehicle V is present may be used.

The external sensor 3 is detection equipment that, detects a situation (surrounding environment) surrounding the host vehicle V. The external sensor 3 includes at least one of a camera and a radar sensor. The camera is imaging equipment that images a situation outside the host vehicle V. As an example, the camera is provided on a rear side of a windshield of the host vehicle V. The camera may be a monocular camera or may be a stereo camera. The stereo camera has two imaging units arranged so as to reproduce binocular parallax. Imaging information of the stereo camera also includes information (distance information) in a depth direction of a captured image. The camera transmits the imaging information relating to the situation outside the host vehicle V to the ECU 10.

The radar sensor is detection equipment that detects an obstacle surrounding the host vehicle V using an electric wave (for example, millimeter wave) or light. The radar sensor includes, for example, at least one of a millimeter wave radar and light detection and ranging [LIDAR]. The radar sensor transmits an electric wave or light surrounding the host vehicle V and receives an electric wave or light reflected from an obstacle to detect the obstacle. The radar sensor transmits detected obstacle information to the ECU 10.

The internal sensor 4 is detection equipment that detects a traveling state of the host vehicle V. The internal sensor 4 includes a vehicle speed sensor, an acceleration sensor, and a yaw rate sensor. The vehicle speed sensor is a detector that detects a speed of the host vehicle V. As the vehicle speed sensor, for example, a wheel speed sensor that is provided in a wheel of the host vehicle V, a drive shaft rotating integrally with the wheel or the like, and detects a rotation speed of the wheel. The vehicle speed sensor transmits detected speed information of the host vehicle V to the ECU 10.

The acceleration sensor is a detector that detects an acceleration of the host vehicle Y. The acceleration sensor may include a longitudinal acceleration sensor that detects a longitudinal acceleration of the host vehicle V, and a lateral acceleration sensor that detects a lateral acceleration of the host vehicle V. The acceleration sensor transmits detected acceleration information of the host vehicle V to the ECU 10. The yaw rate sensor is a detector that delects a yaw rate (rotational angular velocity) of the center of gravity of the host vehicle V around a vertical axis. As the yaw rate sensor, for example, a gyro sensor is used. The yaw rate sensor transmits detected yaw rate information of the host vehicle V to the ECU 10.

The map database 5 is a database that stores map information. The map database 5 is formed in, for example, a hard disk drive [HDD] mounted in the host vehicle V. The “map information” is information stored in advance in the map database 5 of the host vehicle V in information relating to a map. The map information includes, for example, positional information of roads, information (for example, classifications of curves and straight portions, curvatures of curves, and the like) of road shapes, width information of roads, height information of roads, positional information of intersections, positional information of merging points (merging sections), positional information of branch points, positional information of buildings, and the like. In particular, the map information includes, for example, a road shape in a merging section. For example, the map information includes the shapes of the traveling lane L1 and the merging destination lane L2 in the merging section S of the road R of FIG. 2. The map database 5 may be formed in a server of a facility, such as a management center, communicable with the host vehicle V.

The HMI 6 is an interface that is provided to perform an input and an output of information between the vehicle control device 1 and a driver or the like of the host vehicle V. As an example, the HMI 6 includes a display, a speaker, and the like. The HMI 6 performs an image output on the display and a voice output from the speaker in response to a control signal from the ECU 10. The display may be a head-up display. As an example, the HMI 6 includes input equipment (a touch panel, buttons, a voice input unit, and the like) that is provided to receive an input from the driver or the like.

The actuator 7 is equipment that is used for control of the host vehicle V. The actuator 7 includes at least a throttle actuator, a brake actuator, and a steering actuator. The throttle actuator controls a supply amount (throttle valve opening degree) of air to an engine in response to a control from the ECU 10. thereby controlling drive power of the host vehicle V. In a case where the host vehicle V is a hybrid vehicle, in addition to the supply amount of air to the engine, a control signal from the ECU 10 is input to a motor as a power source, and the drive power of the host vehicle V is controlled. In a case where the host vehicle V is an electric vehicle, a control signal from the ECU 10 is input to a motor (a motor functioning as an engine) as a power source, and the drive power of the host vehicle V is controlled. In these cases, the motor as a power source constitutes the actuator 7.

The brake actuator controls a brake system in response to a control signal from the ECU 10, and controls braking force to be given to the wheels of the host vehicle V. As the brake system, for example, a hydraulic brake system can be used. The steering actuator controls the drive of an assist motor configured to control steering torque in an electric power steering system in response to a control signal from the ECU 10. With this, the steering actuator controls steering torque of the host vehicle V.

Next, the functional configuration of the ECU 10 will be described. The ECU 10 has a non-host vehicle situation acquisition unit 11, a road shape acquisition unit 12, a merging permission and prohibition determination unit 13, a manual operation notice unit 14, a manual operation proposition unit 15, a merging completion determination unit 16, and a traveling controller 17.

The non-host vehicle situation acquisition unit 11 acquires a merging destination non-host vehicle situation on the merging destination lane L2. The “merging destination non-host vehicle situation” is information including a relative position and a relative speed of a non-host vehicle (here, the non-host vehicles X1, X2, X3) traveling on the merging destination lane L2 with respect to the host vehicle V. The non-host vehicle situation acquisition unit 11 acquires the merging destination non-host vehicle situation, for example, based on the surrounding environment of the host vehicle V recognized from detection results of the camera and the radar sensor as the external sensor 3.

The road shape acquisition unit 12 acquires a relative road shape with respect to the host vehicle V. As an example, the road shape acquisition unit 12 acquires a shape and an end position of the traveling lane L1 in the merging section S based on the host vehicle V. The road shape acquisition unit 12 acquires the relative road shape with respect to the host vehicle V, for example, based on the positional information of the host vehicle V measured by the GPS receiver 2 and the map information of the map database 5. The road shape acquisition unit 12 may acquire the relative road shape with respect to the host vehicle V based on the surrounding environment of the host vehicle V recognized from the detection results of the camera and the radar sensor as the external sensor 3.

The merging permission and prohibition determination unit 13 determines whether or not the host vehicle V during autonomous driving is able to merge from the traveling lane L1 into the merging destination lane L2 while keeping autonomous driving based on the merging destination non-host vehicle situation acquired by the non-host vehicle situation acquisition unit 11 and the road shape acquired by the road shape acquisition unit 12.

For example, the merging permission and prohibition determination unit 13 may acquire an inter-vehicle distance between the non-host vehicles in the merging destination lane L2 based on the merging destination non-host vehicle situation and may determine whether or not the host vehicle V is able to merge while keeping autonomous driving based on the acquired inter-vehicle distance. The merging permission and prohibition determination unit 13 may acquire a relative speed of each non-host vehicle with respect to the host vehicle V based on the merging destination non-nost vehicle situation and may determine whether or not the host vehicle V is able to merge while keeping autonomous driving based on the acquired relative speed of each non-host vehicle. The merging permission and prohibition determination unit 13 may acquire a distance from a current position of the host vehicle V to an end position of the traveling iane L1 based on the relative road shape with respect to the host vehicle V and may determine whether or not the host vehicle V is able to merge while keeping autonomous driving based on the acquired distance. The merging permission and prohibition determination unit 13 may determine whether or not the host vehicle V is able to merge while keeping autonomous driving using these kinds of information in combination.

In a case where the merging permission and prohibition determination unit 13 determines that the host vehicle V is not able to merge while keeping autonomous driving, the manual operation notice unit 14 gives the driver a notice that the driver of the host vehicle V needs to perform a manual operation to make the host vehicle V merge from the traveling lane L1 into the merging destination lane L2. For example, the manual operation notice unit 14 transmits a control signal to the HMI 6 and makes the HMI 6 perform an image output on the display or a voice output from the speaker, thereby giving the driver the notice that the driver needs to perform the manual operation.

In a case where the merging permission and prohibition determination unit 13 determines that the host vehicle V is not able io merge while keeping autonomous driving, as described below, when traveling of the host vehicle V through autonomous driving is controlled by the traveling controller 17, and the host vehicle V and the merging destination non-host vehicle situation are brought into a merging preparation situation, the manual operation proposition unit 15 proposes starting the manual operation to make the host vehicle V merge from the traveling lane L1 into the merging destination lane L2 to the driver of the host vehicle V.

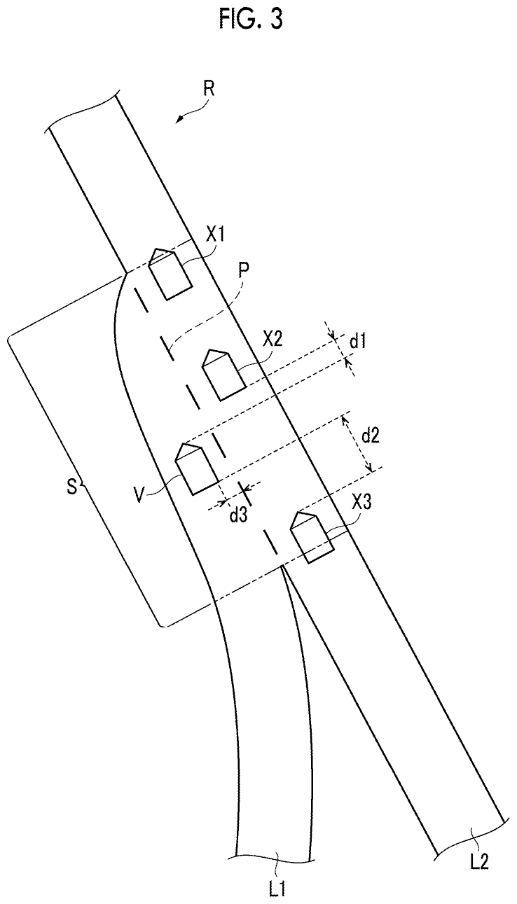

The “merging preparation situation” is a situation in which the driver of the host vehicle V is likely to start the manual operation to make the host vehicle V merge from the traveling lane L1 into the merging destination lane L2. FIG. 3 is a schematic view showing an example of the merging preparation situation in the road shape of FIG. 2. As shown in FIG. 3, the merging preparation situation is. for example, a situation in which the relative position of each of the non-host vehicles X1, X2, X3 with respect to the host vehicle V satisfies conditions set in advance, and the relative speed of each of the non-host vehicles X1, X2, X3 with respect to the host vehicle V satisfies conditions set in advance.

More specifically, the merging preparation situation may be, for example, a situation in which all of the following first to fourth conditions are satisfied. The first condition is that a distance d1 in the moving direction between the host vehicle V and a non-host vehicle (the non-host vehicle X2) of FIG. 3 traveling immediately before the host vehicle V in the moving direction among the non-host vehicles traveling on the merging destination lane L2 is equal to or less than a distance set in advance. The second condition is that a distance d2 in the moving direction between the host vehicle V and a non-host vehicle (the non-host vehicle X3 of FIG. 3) traveling immediately after the host vehicle V in the moving direction among the non-host vehicles traveling on the merging destination lane L2 is equal to or greater than a distance set in advance. The third condition is that a relative speed of the non-host vehicle (the non-host vehicle X2 of FIG. 3) traveling immediately before the host vehicle V in the moving direction among the non-host vehicles traveling on the merging destination lane L2 with respect to the host vehicle V is equal to or less than a threshold set in advance. The fourth condition is that a relative speed of the non-host vehicle (the non-host vehicle X3 of FIG. 3) traveling immediately after the host vehicle V in the moving direction among the non-host vehicles traveling on the merging destination lane L2 with respect to the host vehicle V is equal to or less than a threshold set in advance. The merging preparation situation is not limited to the above-described situation. For example, the merging preparation situation may include a condition that a distance d3 in the lane width direction between a division line P dividing the traveling lane L1 and the merging destination lane L2 and the host vehicle V is equal to or less than a distance set in advance.

For example, the manual operation proposition unit 15 transmits a control signal to the HMI 6 and makes the HMI 6 perform an image output on the display or a voice output from the speaker, thereby proposing starting the manual operation to make the host vehicle V merge from the traveling lane L1 into the merging destination lane L2 to the driver of the host vehicle V during autonomous driving. More specifically, the manual operation proposition unit 15 may display an image of an arrow pointing out the merging destination lane L2 side on the display of the HMI 6 or may output, from the speaker of the HMI 6, a message to the effect that the proposal of the start of merging is performed. The manual operation proposition unit 15 may transmit a control signal to the steering actuator and may make a steering wheel vibrate with the steering actuator, thereby proposing starting the manual operation to make the host vehicle V merge from the traveling lane L1 into the merging destination lane L2 to the driver of the host vehicle V.

After the manual operation proposition unit 15 proposes starting the manual operation to make the host vehicle V merge from the traveling lane L1 into the merging destination lane L2 to the driver, the merging completion determination unit 16 determines whether or not merging of the host vehicle V from the traveling lane L1 into the merging destination lane L2 is completed by a timing set in advance. The above-described timing may be set to any timing. For example, the above-described timing may be set to a timing when a time set in advance elapses or a timing when the host vehicle V travels at a distance set in advance after the manual operation proposition unit 15 proposes starting the manual operation to make the host vehicle V merge from the traveling lane L1 into the merging destination lane L2 to the driver.

The merging completion determination unit 16 determines whether or not merging of the host vehicle V from the traveling lane L1 into the merging destination lane L2 is completed by a known method. For example, the merging completion determination unit 16 may determine that merging of the host vehicle V from the traveling lane L1 into the merging destination lane L2 is completed based on the surrounding environment of the host vehicle V recognized from the detection results of the camera and the radar sensor as the external sensor 3 when confirmation is made that the host vehicle V moves to the merging destination lane L2 beyond the division line P dividing the traveling lane L1 and the merging destination lane L2.

The traveling controller 17 executes autonomous driving of the host vehicle V toward a destination according to a traveling plan. The traveling controller 17 transmits a control signal to the actuator 7 of the host vehicle V, thereby executing autonomous driving of the host vehicle V. The traveling controller 17 generates a traveling plan along a target route to a destination set in advance based on the positional information of the host vehicle V measured by the GPS receiver 2, the map information of the map database 5, the surrounding environment (the positions of the non-host vehicles, and the like) of the host vehicle V recognized from the detection results of the camera and the radar sensor as the external sensor 3, and a vehicle state of the host vehicle V recognized from detection results of the internal sensor 4. The destination may be set by the driver or the like through the HMI 6. The target route may be set based on the destination by a known navigation system.

In a case where the host vehicle V is able to merge from the traveling lane L1 into the merging destination lane L2 in autonomous driving of the host vehicle V, the traveling controller 17 performs vehicle control for automatically performing merging of the host vehicle V. While autonomous driving of the host vehicle V is executed, in a case where the merging permission and prohibition determination unit 13 determines that the host vehicle V is not able to merge from the traveling lane L1 into the merging destination lane L2 while keeping autonomous driving, the traveling controller 17 controls traveling of the host vehicle V through autonomous driving such that the host vehicle V and the merging destination non-host vehicle situation are brought into the merging preparation situation, or the host, vehicle V travels to match a flow of the merging destination non-host vehicle.

After the manual operation proposition unit 15 proposes starting the manual operation to make the host vehicle V merge from the traveling lane L1 into the merging destination lane L2 to the driver, in a case where the driver performs the manual driving (for example, a steering operation), the traveling controller 17 interrupts autonomous driving of the host vehicle V. Thereafter, in a case where the merging completion determination unit 16 determines that merging of the host vehicle V from the traveling lane L1 into the merging destination lane L2 is completed, the traveling controller 17 restarts the interrupted autonomous driving of the host vehicle V, The traveling controller 17 may execute various kinds of driving assistance to the host vehicle V even while autonomous driving of the host vehicle V is interrupted.

After the manual operation proposition unit 15 proposes starting the manual operation to make the host vehicle V merge from the traveling lane L1 into the merging destination lane L2 to the driver, in a case where the merging completion determination unit 16 determines that merging of the host vehicle V from the traveling lane LI into the merging destination lane L2 is not completed by the timing set in advance, the traveling controller 17 stops the host vehicle V through autonomous driving. For example, the traveling controller 17 transmits the control signal to the actuator 7 to operate the actuator 7 while confirming the situation surrounding the host vehicle V based on the imaging information, object information, or the like received from the external sensor 3, thereby stopping the host vehicle V. In a case of stopping the host vehicle V, the traveling controller 17 may set a stop point in advance based on the imaging information, the object information, or the like received from the external sensor 3 and may make the host vehicle V travel to the set stop point (limp home). The “stop point” is a point where the host vehicle V is stopped by the traveling controller 17. The stop point may be set to, for example, a road shoulder or a turnout taking into consideration the host vehicle V and the situation surrounding the vehicle.

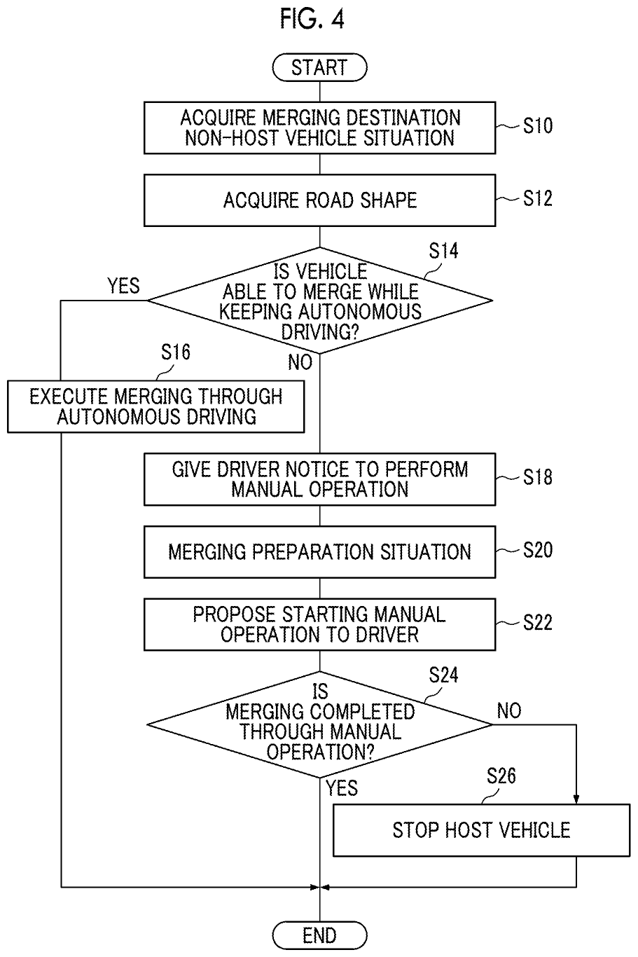

Subsequently, the cooperative merging processing in the vehicle control device 1 will be described. FIG. 4 is a flowchart showing the cooperative merging processing. The flowchart of FIG. 4 is started in a situation in which a vehicle during autonomous driving is about to merge. Here, as an example, in the situation shown in FIGS. 2 and 3, a situation in which the host vehicle V during autonomous driving is about to merge from the traveling lane L1 into the merging destination lane L2 will be described.

As shown in FIG. 4, in Step S10, the vehicle control device 1 acquires, with the non-host vehicle situation acquisition unit 11, the merging destination non-host vehicle situation on the merging destination lane L2 based on the surrounding environment of the host vehicle V recognized from the detection results of the camera and the radar sensor as the external sensor 3. Thereafter, the vehicle control device 1 progresses to Step S12.

In Step S12, the vehicle control device 1 acquires, with the road shape acquisition unit 12, the relative road shape with respect to the host vehicle V based on the positional information of the host vehicle V measured by the GPS receiver 2 and the map information of the map database 5. Thereafter, the vehicle control device 1 progresses to Step S14.

In Step S14, the vehicle control device 1 determines, with the merging permission and prohibition determination unit 13, whether or not the host vehicle V during autonomous driving is able to merge from the traveling lane L1 into the merging destination lane L2 while keeping autonomous driving based on the merging destination non-host vehicle situation acquired by the non-host vehicle situation acquisition unit 11 and the road shape acquired by the road shape acquisition unit 12. In a case where determination is made that the host vehicle V during autonomous driving is able to merge from the traveling lane L1 into the merging destination lane L2 while keeping autonomous driving (Step S14: YES), the vehicle control device 1 progresses to Step S16. On the other hand, in a case where determination is made that the host vehicle V during autonomous driving is not able to merge from the traveling lane L1 into the merging destination lane L2 while keeping autonomous driving (Step S14: NO), the vehicle control device 1 progresses to Step S18.

In Step S16, the vehicle control device 1 executes, with the traveling controller 17, merging of the host vehicle V from the traveling lane L1 into the merging destination lane L2 through autonomous driving. As above, the vehicle control device 1 ends the present cooperative merging processing.

In Step S18, the vehicle control device 1 gives, with the manual operation notice unit 14, the driver a notice that the driver of the host vehicle V needs to perform the manual operation to make the host vehicle V merge from the traveling lane L1 into the merging destination lane L2. Thereafter, the vehicle control device 1 progresses to Step S20.

In Step S20, the vehicle control device 1 controls, with the traveling controller 17, traveling of the host vehicle V through autonomous driving so as to bring the merging preparation situation, in which the driver of the host vehicle V is likely to start the manual operation to make the host vehicle V merge from the traveling lane L1 into the merging destination lane L2, or such that the host vehicle V travels to match a flow of the merging destination non-host vehicle. More specifically, the traveling controller 17 transmits the control signal to the actuator 7 of the host vehicle V to execute autonomous driving of the host vehicle V based on the surrounding environment or the like of the host vehicle V recognized from the detection results of the camera and the radar sensor as the external sensor 3 such that the host vehicle V and the merging destination non-host vehicle situation are brought into the merging preparation situation. After the host vehicle V and the merging destination non-host vehicle situation are brought into the merging preparation situation, the vehicle control device 1 progresses to Step S22.

In Step S22, the vehicle control device 1 proposes, with the manual operation proposition unit 15, starting the manual operation to make the host vehicle V merge from the traveling lane L1 into the merging destination lane L2 to the driver of the host vehicle V. Thereafter, in a case where the driver performs the manual driving (for example, a steering operation), the vehicle control device 1 interrupts autonomous driving of the host vehicle V by the traveling controller 17. Thereafter, the vehicle control device 1 progresses to Step S24.

In Step S24, the vehicle control device 1 determines, with the merging completion determination unit 16, whether or not merging of the host vehicle V from the traveling lane L1 into the merging destination lane L2 is completed by the timing set in advance after the manual operation proposition unit 15 proposes starting the manual operation to make the host vehicle V merge from the traveling lane L1 into the merging destination lane L2 to the driver. In a case where determination is made that merging of the host vehicle V from the traveling lane L1 into the merging destination lane L2 is completed by the timing set in advance (Step S24: YES), the vehicle control device 1 restarts the interrupted autonomous driving of the host vehicle V with the traveling controller 17 and ends the present cooperative merging processing. In a case where determination is made that the merging of the host vehicle V from the traveling lane L1 into the merging destination lane L2 is not completed by the timing set in advance (Step S24: YES), the vehicle control device 1 restarts the interrupted autonomous driving of the host vehicle V with the traveling controller 17 and progresses to Step S26.

In Step S26, the vehicle control device 1 stops the host vehicle V with the traveling controller 17 through autonomous driving. As above, the vehicle control device 1 ends the present cooperative merging processing.

As described above, with the vehicle control device 1, determination is made whether or not the host vehicle V is in a situation to be able to merge while keeping autonomous driving based on the merging destination non-host vehicle situation including the relative position and the relative speed of each of the non-host vehicles X1, X2, X3 traveling on the merging destination lane L2 %viih respect to the host vehicle V and the relative road shape with respect to the host vehicle V. In a case where determination is made that the host vehicle V is not able to merge while keeping autonomous driving, traveling of the host vehicle V through autonomous driving is controlled so as to bring the merging preparation situation, in which the driver of the host vehicle V is likely to start the manual operation to make the host vehicle V merge from the traveling lane L1 into the merging destination lane L2. Then, when the host vehicle V and the merging destination non-host vehicle situation are brought into the merging preparation situation, the proposal of starting the manual operation to make the host vehicle V merge from the traveling lane L1 into the merging destination lane L2 to the driver is performed. For this reason, the vehicle control device 1 can more appropriately support merging in the limited merging section S where all operations are hardly performed through manual driving of the driver since the merging preparation situation is brought through autonomous driving.

The vehicle control device I includes the merging completion determination unit 16 that, after the manual operation proposition unit 15 proposes starting the manual operation to make foe host vehicle V merge from the traveling lane L1 into the merging destination lane L2 to the driver, determines whether or not merging of the host vehicle V from the traveling lane L1 into the merging destination lane L2 is completed by the timing set in advance. In a case where the merging completion determination unit 16 determines that merging of the host vehicle V from the traveling lane L1 into the merging destination lane L2 Is not completed by the timing, the traveling controller 17 stops the host vehicle V. With this, in a case where the driver who receives the proposal of starting the manual operation to make the host vehicle V merge from the traveling lane L1 into the merging destination lane L2 cannot appropriately complete merging of the host vehicle V, it is possible to automatically stop the host vehicle V. For this reason, the driver easily concentrates on the manual operation to make the host vehicle V merge without being distracted by retreat or the like of foe host vehicle in a case where merging of the host vehicle V cannot be completed. Accordingly, the vehicle control device 1 can more appropriately support merging in the merging section S.

In a case where the merging section S is comparatively short, there is a concern that the driver hesitates to accelerate the host vehicle V at a sufficient acceleration through manual driving. Furthermore, since the driver needs to perform surrounding monitoring and the steering operation simultaneously with accelerating the host vehicle V, the degree of difficulty of merging through manual driving is further increased for the driver. In contrast, with the vehicle control device 1, traveling of the host vehicle V is controlled through autonomous driving, whereby it is possible to more reliably accelerate the host vehicle V at a sufficient acceleration. Accordingly, the vehicle control device 1 can more appropriately support merging in the merging section S in a situation in which the merging section S is particularly short and the degree of difficulty of merging through manual driving is particularly high in this way.

The above-described embodiment may be subjected to various modifications and improvements based on common knowledge of those skilled in the art.

For example, the merging section S may be a section where the traveling lane L1 merges with the merging destination lane L2 in the road R, and is not limited to the area (the area sandwiched between the two two-dot-chain lines in the road R) shown in FIG. 2. The merging section S may be defined as an area narrower or an area wider than the area shown in FIG. 2.

In a case where the merging permission and prohibition determination unit 13 performs that the host vehicle V is not able to merge while keeping autonomous driving, the vehicle control device 1 may not give the driver the notice that the driver of the host vehicle V needs to perform the manual operation to make the host vehicle V merge from the traveling lane L1 into the merging destination lane L2. In this case, the ECU 10 of the vehicle control device 1 may not have the manual operation notice unit 14.

After the manual operation proposition unit 15 proposes starting the manual operation to make the host vehicle V merge from the traveling lane L1 into die merging destination lane L2 to the driver, the vehicle control device 1 may not determine whether or not merging of the host vehicle V from the traveling lane L1 into the merging destination lane L2 is completed by the timing set in advance. In this case, the ECU 10 of the vehicle control device 1 may not have the merging completion determination unit 16.

After the manual operation proposition unit 15 proposes starting the manual operation to make the host vehicle V merge from the traveling lane L1 into the merging destination lane L2 to the driver, the vehicle control device 1 may not stop the host vehicle V with the traveling controller 17 depending on the host vehicle V and the situations surrounding the vehicle regardless of whether or not the merging completion determination unit 16 determines that merging of the host vehicle V from the traveling lane L1 into foe merging destination lane L2 is completed by the timing set in advance.

What is claimed is:

1. A vehicle control device that, in a host vehicle that is able to execute autonomous driving, supports merging of the host vehicle from a traveling lane into a merging destination lane, the vehicle control device comprising:
a non-host vehicle situation acquisition unit configured to acquire a merging destination non-host vehicle situation including a relative position and a relative speed of a non-host vehicle traveling on the merging destination lane with respect to the host vehicle;
a road shape acquisition unit configured to acquire a relative road shape with respect to the host vehicle;
a merging permission ancl prohibition determination unit configured to determine whether or not the host vehicle during autonomous driving is able to merge from the traveling lane into the merging destination lane while keeping autonomous driving based on the merging destination non-host vehicle situation and the road shape;
a traveling controller configured to, in a case where the merging permission and prohibition determination unit determines that the host vehicle is not able to merge while keeping autonomous driving, control traveling of the host vehicle through autonomous driving so as to bring a merging preparation situation, in which a driver of the host vehicle is likely to start a manual operation to make the host vehicle merge from the traveling Jane into the merging destination lane; and
a manual operation proposition unit configured to, in a case where the host vehicle and the merging destination non-host vehicle situation are brought into the merging preparation situation, propose starting the manual operation to make the host vehicle merge from the traveling lane into the merging destination lane to the driver.

2. The vehicle control device according to claim 1, further comprising a merging completion determination unit configured to, after the manual operation proposition unit proposes starting the manual operation to make the host vehicle merge from the traveling lane into the merging destination lane to the driver, determine whether or not merging of the host vehicle from the traveling lane into the merging destination lane is completed by a timing set in advance,
wherein the traveling controller is configured to, in a case where the merging completion determination unit determines that merging of the host vehicle from the traveling lane into the merging destination lane is not completed by the timing, stop the host vehicle.

3. The vehicle control device according to claim 2, wherein, when the merging permission and prohibition determination unit determines that the host vehicle autonomous driving is able to merge from the traveling lane into the merging destination lane, and the driver starts the manual operation in reply to the propose, made by the manual operation proposition unit, starting the manual operation to make the host vehicle merge from the traveling lane into the merging destination lane, the traveling controller interrupts autonomous driving of the host vehicle.

4. The vehicle control device according to claim 3, wherein, when the merging completion determination unit determines that merging of the host vehicle from the traveling lane into the merging destination lane is completed, the traveling controller restarts the interrupted autonomous driving of the host vehicle.
